(19) United States
(12) Patent Application Publication
(10) Pub. No.: US 2026/0052442 A1
(43) Pub. Date: Feb. 19, 2026

(54) MULTIPLE CONDITIONAL CONFIGURATIONS FOR THE SAME HANDOVER REQUEST

(71) Applicant: Nokia Technologies Oy, Espoo (FI)

(72) Inventors: Halit Murat GÜRSU, Munich (DE); Ahmad AWADA, Munich (DE); Panagiotis SPAPIS, Munich (DE); Umur KARABULUT, Munich (DE); Krzysztof KORDYBACH, Wroclaw (PL)

(21) Appl. No.: 19/102,052

(22) PCT Filed: Jun. 23, 2023
(86) PCT No.: PCT/EP2023/067173

§ 371 Date: Feb. 7, 2025

(30) Foreign Application Priority Data
Aug. 8, 2022 (FI) 20225706

(51) Int. Cl. H04W 36/08; H04W 36/00

(52) U.S. Cl. CPC H04W 36/08; H04W 36/0085

(57) ABSTRACT

Described herein is a first network node that that controls a source cell for a user equipment, UE, in a radio access network, the first network node being a master node for carrier aggregation or dual connectivity of the UE in the radio access network, comprising at least one processor; and at least one memory storing instructions that, when executed by the at least one processor, cause the first network node at least to: determine a conditional handover for the UE that is served by the source cell; transmit a conditional handover request for the UE to a second network node that controls potential target cells for the UE in the radio access network, the second network node being a target master node for the carrier aggregation or dual connectivity of the UE; receive a conditional handover request acknowledgement from the second network node comprising at least one conditional configuration of target cells for the handover; and maintain a number of conditional configurations for the UE.

### TECHNOLOGY

The present disclosure relates to conditional handovers and in particular to multiple conditional configurations for the same handover request.

### BACKGROUND

Any discussion of the background art throughout the specification should in no way be considered as an admission that such art is widely known or forms part of common general knowledge in the field.

In Rel. 16, conditional handovers (CHO) are introduced. The user equipment (UE) is configured with CHO target cell configurations and at least one CHO execution condition to decide on when to execute the handover to one or multiple prepared target cells. When the UE evaluates the CHO conditions and a condition holds for a specific target cell, the UE applies the CHO configuration of the target cell and switches to this target cell. Currently, the UE is limited to have a maximum of 8 conditional configurations to be considered in CHO.

During the CHO procedure, a target radio access network (RAN) node is not aware of the number of already existing conditional configurations at the UE side and sends multiple conditional configurations for primary cells of a secondary cell group (PSCells) as an answer to a single CHO request to a source RAN node. On the other side, the source node does not know which of the prepared PSCells have better radio conditions and are more important. Thus, the source node cannot select the best PSCells and their corresponding conditional configurations for presentation to the UE.

Thus, there is a need to limit and control the number of conditional configurations for CHO provided to the UE.

### SUMMARY

In accordance with an aspect of the present disclosure, there is provided a first network node configured to support establishing a connection towards a user equipment, UE, via a radio access network, the first network node comprising: at least one processor; and at least one memory storing instructions that, when executed by the at least one processor, cause the first network node at least to: determine to prepare a conditional handover for the UE towards a second network node based on measurements performed by the UE; transmit a conditional handover request for the UE towards the second network node, wherein the conditional handover request includes an indication related to a number of conditional configurations the second network node is allowed to prepare for the handover; and receive a conditional handover request acknowledgement from the second network node comprising at least one conditional configuration related to at least one target cell for the handover.

In some examples, the network node is configured to: maintain a number of conditional configurations allocated to the UE, and to update the number after receiving the conditional handover request acknowledgement.

In some examples, the network node is configured to: determine a maximum number of conditional configurations allocatable to and/or supported by the UE.

In some examples, the network node is configured to: transmit a conditional handover request for the UE towards a third network node, wherein the conditional handover request includes an indication related to a number of conditional configurations the third network node is allowed to prepare for the handover, wherein the number is coordinated with the number sent to the second node and the maximum number supported by the user equipment.

In some examples, the network node is configured to: transmit a message towards the UE comprising an indication related to the received at least one conditional configuration related to the at least one target cell of the second network node.

In some examples, the conditional handover request acknowledgement comprises a number of the at least one conditional configuration included in the conditional handover request acknowledgement.

In accordance with an aspect of the present disclosure, there is provided a first network node configured to support establishing a connection towards a user equipment, UE, via a radio access network, the first network node comprising: at least one processor; and at least one memory storing instructions that, when executed by the at least one processor, cause the first network node at least to: determine to prepare a conditional handover for the UE towards a second network node based on measurements performed by the UE; transmit a conditional handover request for the UE towards the second network node; and receive a conditional handover request acknowledgement from the second network node comprising an indication that at least one additional conditional configuration related to one or more further target cells is available for the handover.

In some examples, the first network node is configured to: determine whether the UE can be allocated with at least one more conditional configuration and in this case, transmit a further conditional handover request to the second network node to obtain another conditional configuration related to a further target cell.

In some examples, the further conditional handover request comprises an indication that the second network node shall not release existing preparations for target cells and return another conditional configuration related to a further target cell (PSCell-2) in another conditional handover request acknowledgement.

In some examples, the conditional handover request acknowledgement comprises a conditional configuration for a primary cell of a main cell group and a primary cell of a secondary cell group and the another conditional handover request acknowledgement comprises a conditional configuration for another primary cell of a secondary cell group.

In some examples, the conditional handover request acknowledgement comprises a conditional configuration for a primary cell of a main cell group and a primary cell of a secondary cell group and the another conditional handover request acknowledgement comprises a conditional configuration for another primary cell of a secondary cell group and the same primary cell of the main cell group.

In some examples, the first network node is configured to: compile conditional configurations received with different conditional handover request acknowledgements for the same UE, and transmit a message towards the UE comprising an indication related to the compiled at least one conditional configuration related to the at least one target cell of the second network node.

In some examples, the conditional handover request acknowledgement comprises a unique identifier associated with a conditional configuration included in the conditional handover request acknowledgement.

In some examples, the conditional handover request includes a request to prepare a conditional handover towards the second network node and a secondary node, wherein the first network node is further configured to: receive a conditional handover request acknowledgement from the second network node comprising the at least one conditional configuration related to at least one target cell of the second network node and at least one secondary cell of the secondary node.

In some examples, the first network node is a source master node for dual connectivity of the UE in the radio access network, the second network node is a target master node for the dual connectivity of the UE, the conditional handover request comprises an indication of a primary cell, PCell, associated with the second network node and the conditional handover request acknowledgement comprises one or more indications of secondary cells, PSCells, associated with the secondary node.

In some examples, the first network node is configured to: receive from the UE an indication of the number of conditional configurations for conditional handover that the UE can support.

In accordance with an aspect of the present disclosure, there is provided a second network node configured to support establishing a connection towards a user equipment, UE, via a radio access network, the second network node comprising: at least one processor; and at least one memory storing instructions that, when executed by the at least one processor, cause the second network node at least to: receive a conditional handover request for the UE from a first network node, the conditional handover request comprising an indication related to a number of conditional configurations the second network node is allowed to prepare for the handover; determine, based on the received conditional handover request, that multiple target cells controlled by the second network node are to be prepared for the handover; and transmit a conditional handover request acknowledgement towards the first network node comprising at least one conditional configuration related to at least one target cell for the handover.

In some examples, the received conditional handover request comprises information on radio measurements for target cells made by the UE and the second network node is configured to: determine a number of target cells and of respective conditional configurations potentially available for the conditional handover request based on the radio measurements and the number of conditional configurations the second network node is allowed to prepare for the handover.

In some examples, the second network node is configured to: transmit a request for preparing a plurality of target cells for the handover towards a secondary node; and receive an acknowledgement from the secondary node comprising conditional configurations for the prepared target cells.

In some examples, the second network node is a target master node for dual connectivity of the UE in the radio access network, the request for preparing a plurality of target cells is a secondary node, SN, addition request, and the conditional handover request comprises an indication of a primary cell, PCell, associated with the second network node, and the conditional handover request acknowledgement comprises one or more indications of secondary cells, PSCells, associated with the secondary node.

In accordance with an aspect of the present disclosure, there is provided a second network node configured to support establishing a connection towards a user equipment, UE, via a radio access network, the second network node comprising: at least one processor; and at least one memory storing instructions that, when executed by the at least one processor, cause the second network node at least to: receive a conditional handover request for the UE from a first network node, the conditional handover request comprising information on radio measurements for target cells made by the UE; determine that multiple target cells controlled by the second network node are to be prepared for the handover; and transmit a conditional handover request acknowledgement towards the first network node comprising an indication that at least one additional conditional configuration for one or more further target cells is available for the handover.

In some examples, the determining that multiple target cells associated with the second network node are potentially available for the handover is based on the information on radio measurements for target cells.

In some examples, the second network node is configured to: transmit a request for preparing a target cell for the handover to a secondary node, the request for preparing a target cell comprising at least part of the received information on radio measurements for target cells; and receive an acknowledgement from the secondary node comprising a conditional configuration for the prepared target cell, the acknowledgement comprising an indication that multiple target cells controlled by the secondary node are potentially available for the handover.

In some examples, the second network node is configured to: receive a further conditional handover request from the first network node comprising an indication that the second network node shall not release existing preparations for target cells and return another conditional configuration of a further target cell in another conditional handover request acknowledgement.

In some examples, the second network node is configured to: determine to add a further target cell for the handover by transmitting another request for a preparing the further target cell for the handover to the secondary node and receiving another acknowledgement from the secondary node comprising a conditional configuration for the prepared further target cell; and transmit another conditional handover request acknowledgement to the first network node comprising the conditional configuration of the further target cell.

In some examples, a conditional handover request acknowledgement comprises a unique identifier associated with a conditional configuration included in the conditional handover request acknowledgement.

In some examples, the second network node is a target master node for dual connectivity of the UE in the radio access network, the request for preparing a target cell is a secondary node, SN, addition request, and the conditional handover request comprises an indication of a primary cell, PCell, associated with the second network node, and the conditional handover request acknowledgement comprises one or more indications of secondary cells, PSCells, associated with the secondary node.

In accordance with an aspect of the present disclosure, there is provided a user equipment, UE, configured to operate in a radio access network, the UE comprising: at least one processor; and at least one memory storing instructions that, when executed by the at least one processor, cause the UE at least to: indicate towards the network the number of conditional configurations for a conditional handover that the UE can support; transmit measurements for target cells for a potential handover towards a network node; and receive from the network node a message for conditional handover comprising an indication related to at least one conditional configuration related to at least one of the target cells.

In some examples, the user equipment is configured to: evaluate the at least one conditional configuration, and in case at least one condition holds, execute a handover towards the target cell associated with the met condition.

In accordance with an aspect of the present disclosure, there is provided a system, comprising: a first network node as described above and a user equipment, UE, as described above, served by a cell of the first network node.

In accordance with an aspect of the present disclosure, there is provided a method of a first network node configured to support establishing a connection towards a user equipment, UE, via a radio access network, the method comprising: determining to prepare a conditional handover for the UE towards a second network node based on measurements performed by the UE; transmitting a conditional handover request for the UE towards the second network node, wherein the conditional handover request includes an indication related to a number of conditional configurations the second network node is allowed to prepare for the handover; and receiving a conditional handover request acknowledgement from the second network node comprising at least one conditional configuration related to at least one target cell for the handover.

In accordance with an aspect of the present disclosure, there is provided a method of a first network node configured to support establishing a connection towards a user equipment, UE, via a radio access network, the method comprising: determining to prepare a conditional handover for the UE towards a second network node based on measurements performed by the UE; transmitting a conditional handover request for the UE towards the second network node; and receiving a conditional handover request acknowledgement from the second network node comprising an indication that at least one additional conditional configuration related to one or more further target cells is available for the handover.

In accordance with an aspect of the present disclosure, there is provided a method of a second network node configured to support establishing a connection towards a user equipment, UE, via a radio access network, the method comprising: receiving a conditional handover request for the UE from a first network node, the conditional handover request comprising an indication related to a number of conditional configurations the second network node is allowed to prepare for the handover; determining, based on the received conditional handover request, that multiple target cells controlled by the second network node are to be prepared for the handover; and transmitting a conditional handover request acknowledgement towards the first network node comprising at least one conditional configuration related to at least one target cell for the handover.

In accordance with an aspect of the present disclosure, there is provided a method of a second network node configured to support establishing a connection towards a user equipment, UE, via a radio access network, the method comprising: receiving a conditional handover request for the UE from a first network node, the conditional handover request comprising information on radio measurements for target cells made by the UE; determining that multiple target cells controlled by the second network node are to be prepared for the handover; and transmitting a conditional handover request acknowledgement towards the first network node comprising an indication that at least one additional conditional configuration for one or more further target cells is available for the handover.

In accordance with an aspect of the present disclosure, there is provided a method for a user equipment, UE, configured to operate in a radio access network, the method comprising: indicating towards the network the number of conditional configurations for a conditional handover that the UE can support; transmitting measurements for target cells for a potential handover towards a network node; and receiving from the network node a message for conditional handover comprising an indication related to at least one conditional configuration related to at least one of the target cells.

In accordance with an aspect of the present disclosure, there is provided a computer program comprising instructions for causing an apparatus to perform any of the above methods, and a memory storing computer readable instructions for causing an apparatus to perform any of the above methods.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of a signaling/messaging flowchart for conditional handover;

FIG. 2 schematically illustrates an example of a signaling/messaging flowchart for conditional handover according to example embodiments of the present disclosure;

FIG. 3 schematically illustrates another example of a signaling/messaging flowchart for conditional handover according to example embodiments of the present disclosure.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0 (2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the El interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the El interface connected with the gNB-CU-CP and the F1-U interface connected with the gNB-DU, e.g., according to 3GPP TS 38.401 V16.6.0 (2021-07) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.

Or else, e.g., according to 3GPP TR 38.801 V14.0.0 (2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0 (2021-06) section 6 incorporated by reference.

A RAN (Radio Access Network) node or network node like e.g. a gNB, base station, central node, distributed node, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3. A central node may support central unit—control part (CU-CP) and/or central unit—user part (CU-UP) functionality. A distributed node may support distributed unit (DU) functionality.

A network node may be implemented as a master node or a secondary node, or acing as a master node or secondary node. A master node may at least include a central node and/or a distributed node. A secondary node may at least include a central node and/or a distributed node.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0 (2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

According to Rel. 16, the UE can be configured with Conditional Handover (CHO) target cell configurations and at least one CHO execution condition to decide on when to execute the handover to one or multiple prepared target cells. The condition(s) is/are based on radio measurements of the serving cell and target cells. In the CHO configuration, the target cell(s) may have reserved cell radio network temporary identifier (C-RNTI) and contention free radio access (CFRA) resources for the UE. When the UE evaluates the CHO condition and the condition holds for a specific target cell, the UE applies the CHO configuration of the target cell and may use the reserved CFRA resources to initiate a random access to the target cell. The UE can be configured with multiple conditions for multiple target cells.

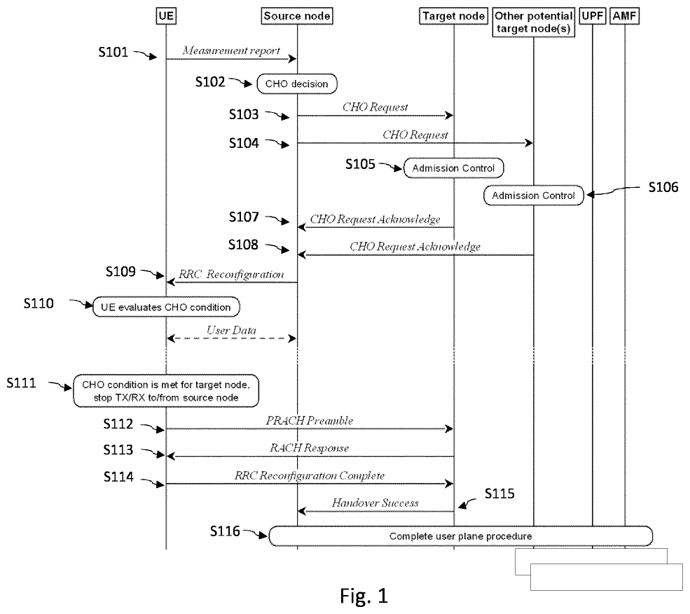

FIG. 1 schematically shows an exemplary implementation for a signalling diagram for CHO. CHO is designed so that the UE can execute the handover autonomously without the need of the serving cell to trigger the handover execution after receiving a measurement report from the UE.

In step S101, the UE sends a measurement report identifying potential neighbour cells for handover. In steps S102-S108, in response to the measurements received in step S101, the source RAN node determines that target cells supporting CHO should be prepared for the UE. The source RAN node sends conditional handover requests to multiple target RAN nodes. In each CHO request message, the source node indicates the cell(s) that shall be prepared by the respective target node. The target RAN nodes perform admission control and send handover request ACK for the requested cell and the related conditional configuration for that cell as a response to the CHO request.

In step S109, the source RAN node sends a RRC reconfiguration message with the conditional configurations related to CHO to the UE. The UE receives this message and continues data exchange with the source node. In steps S110-S111, the UE evaluates the CHO conditions, and executes the conditional configuration for the CHO for which the condition holds. In steps S111-S114, the UE executes CHO towards the selected target cell controlled by the target RAN node and stops TX/RX to/from the source node. In step S115, the target RAN node indicates the handover success to the source RAN node. Finally, in step S116, the user plane procedures such as data forwarding and path switch are completed afterwards.

In case of dual connectivity (DC), the target node (target master node—MN) is supposed to prepare multiple secondary cell groups (SCGs) (in same or different secondary nodes—SNs) upon receiving a conditional handover request from the source node (source MN). This means that:
Option 1: Either the target RAN node sends multiple conditional configurations where each conditional configuration consists of a primary cell (PCell) and a primary/secondary cell (PSCell) configuration as an answer to a single HO request.
Option 2: Or, the target RAN node sends one conditional configuration for a PCell and multiple conditional configurations for PSCells (can be conditional PSCell changes (CPCs) or conditional PSCell additions (CPAs)) as a response to a single HO request.

In both of these options, the target node sends multiple conditional configurations as an answer to a single CHO request.

Typically, a UE is limited to have a maximum number (e.g., 8) of conditional configurations in CHO. A target node, however, is unaware of the limitation at a given point of time at the UE side considering the number of already existing conditional configurations. For example, if the UE is already configured with 6 conditional configurations and the target node provides 4 more conditional configurations, the source node cannot provide these configurations to the UE and must make selections that it is not entitled to (the source node cannot tell which of the prepared PSCells are “more important”, e.g., have better radio conditions). Also, the target node reserves resources that will never be used by the UE if the corresponding PSCells are not used.

Therefore, generally speaking, the present disclosure proposes techniques/mechanisms to limit and control the number of conditional configurations that a target node can prepare through the CHO procedure.

In order to address at least some or all of the above-illustrated issues, according to some example embodiments, the present disclosure generally proposes that the source node indicates to the target node how many conditional configurations should be delivered as an answer to the conditional handover request.

In a broad sense, the present disclosure generally proposes two different possible example methods to control the number of conditional configurations that a target node prepares through the CHO procedure.

According to some possible (but non-limiting) implementations, the source MN triggers an addition with multiple candidate PSCells. For example, the source node indicates to the target node (possibly within the conditional handover request message) the maximum number of conditional configurations that the target node is allowed to prepare and provide in the handover request ACK message. The target node (MN) can use this information to decide how many target SNs it should contact indicating to the respective target SN the number of PSCells to be prepared by the target SN. Thus, the target node uses this information to decide the total number of conditional configurations to be included in the handover acknowledgement message. This embodiment has the benefit that the identification of a CHO preparation is possibly kept as in case of the classic CHO preparation: using the UE IDs and the target PCell. However, in this case, if the CHO is cancelled, it is cancelled with all prepared PSCells because the PSCells configurations are included in a single CHO configuration. Thus, if a PSCell is not valid anymore, the CHO has to be cancelled and reprepared, or the complete CHO has to be updated if only one PSCell needs to be updated.

According to some other possible (but non-limiting) implementations, multiple CHO configurations are requested sequentially and there is single PSCell configuration in one CHO configuration. For example, the target node indicates that it may provide multiple conditional configurations but sends a single conditional configuration (within a legacy CHO Handover Request ACK) as an answer to the conditional handover request. To fetch further conditional configurations, the source node sends further handover requests for the same target PCell. If the source node decides to ask for more configurations, it indicates to the target node, using a new indication (e.g., a flag), e.g., called “CHO-multiply”, that the new CHO request for the same PCell shall not release existing preparations for this PCell. This indication is needed so that the target node doesn't release the previous conditional configurations related to this target PCell, as it would have happened in the classic CHO. In these embodiments, each PSCell configuration is in a separate CHO configuration and each CHO configuration has the same PCell configuration. Since the source node may send multiple new CHO requests relating to the same PCell, the response(s) from the target node must be identified and matched to the request. Therefore, some additional identifier for the responses (e.g., CHO request ACK) may be needed. This embodiment effectively extends the identification of a CHO preparation so that the PSCell is now part thereof. This diverges from the legacy behaviour but allows, in future, to enable, e.g., CHO cancellation related to a particular PSCell.

In embodiments, the UE may inform the network about the number of conditional configurations that the UE can support for a conditional handover. The UE may include this information in an existing message or send a separate message, e.g., to a source node.

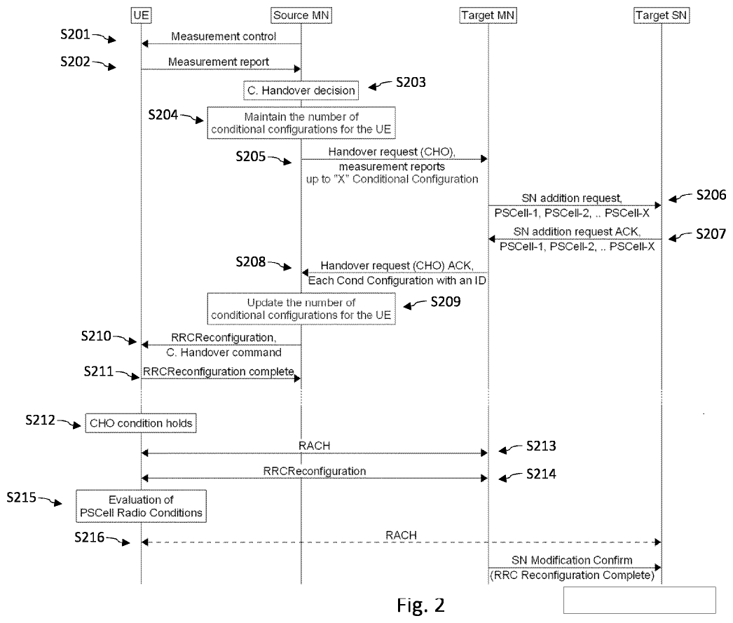

FIG. 2 schematically illustrates an example of a signaling/messaging flowchart according to some example embodiments of the present disclosure.

In general, in the example embodiment of FIG. 2, it may be understood that the Source MN (e.g., a gNB) is configured to make a decision for a conditional handover.

In steps S201 and S202, the UE is configured with a measurement configuration and reports the measurements of neighbour PCells and possibly PSCells to the source MN. In step S203, the source MN determines based on the measurement that a CHO preparation for the UE is necessary or desired. At that time, the source MN may have already received a message from the UE indicating the number of conditional configurations that are allowed for the UE or the UE can support. The source MN may obtain this information also from other sources.

The source MN maintains the number of conditional configurations allowed to the UE in step S204 and determines how many additional conditional configurations can be allocated for the UE. To determine the number of additional conditional configurations, the source MN may take into account the number of conditional PSCell changes (CPC), conditional PSCell additions (CPA), conditional handovers (CHO), low layer mobility (LLM) configurations that are already configured to the UE. A conditional configuration is a PSCell/PCell configuration to be applied with respect to a condition.

In step S205, the source MN sends a conditional handover request message to the target NM and indicates the maximum number X of conditional configurations to be provided for the UE by the target MN. The conditional handover request message may comprise the measurement reports received for the UE.

In the CHO request message, the source node may indicate the target primary cell of the master cell group (PCell) that shall be prepared by the respective target node.

The target node receives the CHO request message and may perform admission control for the received request.

In steps S206 and S207, based on measurements including measurements for candidate PSCells received from the source MN, the target MN determines the number of conditional configurations to be provided to the UE with the conditional handover request ACK. The number of conditional configurations determined by the target MN can be equal to or smaller than X that is indicated in step S205. The target MN determines to indicate the number of PSCells to be prepared by the target SN or target SNs with corresponding SN addition requests. A SN addition request may include a list of PSCells (PSCell-1, PSCell-2, . . . , PSCell-X) that are to be prepared for the handover by the respective SN. The target SNs prepare up to the indicated number of PSCells and send a SN addition request ACK message to the target MN (step S207). The target MN may send SN addition requests to different target SNs. The target MN may collect the responses from different target SNs.

The target MN prepares the conditional configurations received from the SN(s) and possibly the conditions to execute each target PSCell configuration and sends these with a conditional handover request ACK to the source MN (step S208). The target MN may indicate the number of conditional configurations explicitly to the source MN.

Each conditional configuration may be provided with a unique identifier ID. The ID is a unique identifier to differentiate which CHO is refer to for the same PCell because multiple CHOs may be prepared for the same PCell with different PSCells. Using UE ID and PCell ID is not sufficient as the proposed CHOs are for the same UE and the same PCell, but are associated with a separate PSCell. In case that all PSCell config are in the same CHO configuration, UE ID and PCell ID are sufficient to indicate that single CHO configuration.

In step S209, the source MN updates the number of conditional configurations the UE is currently configured with: In one embodiment, the source MN uses the number of conditional configurations explicitly indicated by the target MN in the conditional handover request ACK. In another embodiment, the source MN observes or decodes the configurations provided by the target MN to determine the number of conditional configurations.

In steps S210-S217, the UE is configured with conditional configurations (e.g., with a RRC reconfiguration message). The UE receives this message, sends a confirmation message (e.g., RRC reconfiguration complete in step S211), continues data exchange with the source node, and starts monitoring the conditions for conditional handover. Once conditions are fulfilled (as determined in step S212), the UE executes the PCell change and PSCell addition/change subsequently similar as described with FIG. 1 (wherein step S213 in FIG. 2 corresponds to steps S112 and S113 in FIG. 1; S214 in FIG. 2 corresponds to steps S114 and S115 in FIG. 1; and FIG. 2 includes PSCell access compared to FIG. 1.

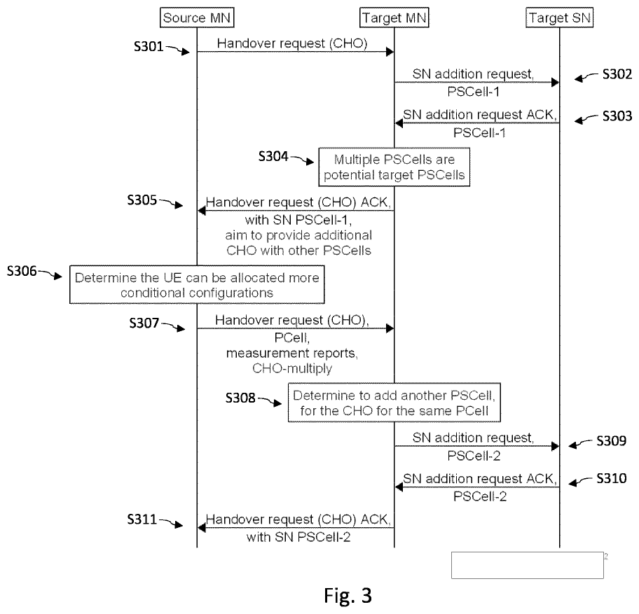

FIG. 3 schematically illustrates another example of a signaling/messaging flowchart according to some example embodiments of the present disclosure. This figure is a reduced flowchart skipping the interaction with the UE to not show the redundant steps indicated by FIG. 2, in particular changing steps S205 and S209 of the previous embodiment (i.e., enhancing the CHO preparation phase).

Again, the source MN may have obtained information as to the number of conditional configurations that are allowed for the UE or the UE can support. For example, the source MN may have received a message from the UE indicating the number of conditional configurations that are allowed for the UE or the UE can support.

In step S301, the source MN sends the conditional handover request to the target MN (compare to step S205). As before the handover request may comprise measurement reports for neighbour PCells and possibly PSCells, and an identification of the PCell that shall be prepared by the target MN.

In steps S302-S303, the target MN sends SN addition request(s) to one or more target SN(s), and each target SN sends an SN addition request ACK message. In case of multiple SNs being involved, the target MN may determine to add the configuration from only one PSCell towards the UE. The SN addition request and the SN addition request ACK are each for a single PSCell, and may indicate the required PSCell. In other words, the SN addition request ACK may include the requested PSCell configuration.

The target SN determines from measurements received from the target MN multiple PSCells that can be added. For this purpose, the target MN may forward measurement reports to the target SN. Alternatively, further input like OAM configuration can be used at target SN side to determine the PSCells that can be added.

The target SN may indicate this to the target MN in the SN addition request ACK message. Alternatively, the target MN may determine based on the measurements received from the source MN that multiple target PSCells can be prepared for the same target PCell.

In step S304, the target MN determines, based on the measurements or the SN addition request ACK message(s), that multiple PSCells can be added for the same target PCell and are potential target PSCells.

In step S305, the target MN sends the conditional handover request ACK with the conditional configuration for the PSCell of the target SN to the source MN, and indicates to the source MN that it aims (i.e., it is possible) to send one or more further conditional configurations for other PSCell(s). The target MN indicates a unique identifier ID for each conditional configuration (compare to step S208).

In step S306, the source MN determines whether the UE can be allocated more conditional configurations. For this, the source MN compares the maximum allowed number of conditional configurations with the actual number of conditional configurations that have been configured on the UE. If it is determined that the UE can handle one or more additional conditional configurations, the procedure continues with step S307.

In step S307, the source MN sends a new conditional handover request to the target MN and adds an indication (or flag) “CHO-multiply” to the request, for the target MN to keep the previous conditional configuration and send a new one. The handover request may comprise measurements reports and an indication of the PCell.

The target MN determines in step S308 to keep the previous CHO preparation(s) and to send another CHO conditional configuration to the source MN. The target MN determines to add another PSCell for the CHO for the same PCell. The target MN sends SN addition request to the target SN and receives SN addition request ACK with the PSCell conditional configuration (steps S309 and S310). In step S311, the target MN sends the conditional handover request ACK with the additional conditional configuration for the additional PSCell of the target SN to the source MN.

Typically, a CHO configuration relates to a PCell and a PSCell. The PCell is kind of an anchor for the CHO configuration. For example, a CHO configuration for PCell1 and PSCell1 is provided with the 1st conditional handover request ACK in step S305. Then, a CHO configuration for PCell1 and PSCell2 is provided with the 2nd conditional handover request ACK in step S311. Thus, in response to further CHO requests marked with the indication (e.g., “CHO-multiply”) to keep the previous conditional configuration and send a new one, conditional configurations for the same PCell but for different PSCells are provided by the target MN in further conditional handover request ACKs.

The procedure may be repeated with step S306 to add further conditional configurations by the source MN, possibly with different target MNs and/or different target SNs, until the required number of conditional configurations has been collected. The procedure may then continue similar to step S210 with the configuration of the UE and the execution of the conditional handover by the UE (steps S212-S217).

To summarize the above, the present disclosure provides techniques/mechanisms to limit and control the number of conditional configurations that a target node can prepare through the CHO procedure. The present disclosure generally proposes that the source node indicates to the target node how many conditional configurations should be delivered as an answer to the conditional handover request. Alternatively, the source node may send multiple conditional handover requests to the target node to retrieve conditional configurations one by one.

Finally, it is nevertheless to be noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, source MN, target MN, target SN, etc.

It should also be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, source MN, target MN, target SN, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, source MN, target MN, target SN, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1-37. (canceled)

38. A first network node configured to support establishing a connection towards a user equipment, UE, via a radio access network, the first network node comprising:
at least one processor; and
at least one memory storing instructions that, when executed by the at least one processor, cause the first network node at least to:
determine to prepare a conditional handover for the UE towards a second network node based on measurements performed by the UE;
transmit a conditional handover request for the UE towards the second network node, wherein the conditional handover request includes an indication related to a number of conditional configurations the second network node is allowed to prepare for the handover; and
receive a conditional handover request acknowledgement from the second network node comprising at least one conditional configuration related to at least one target cell for the handover.

39. The first network node according to claim 38, wherein the network node is configured to:
maintain a number of conditional configurations allocated to the UE, and to update the number after receiving the conditional handover request acknowledgement.

40. The first network node according to claim 38, wherein the network node is configured to:
determine a maximum number of conditional configurations allocatable to and/or supported by the UE.

41. The first network node according to claim 40, wherein the network node is configured to:
transmit a conditional handover request for the UE towards a third network node, wherein the conditional handover request includes an indication related to a number of conditional configurations the third network node is allowed to prepare for the handover, wherein the number is coordinated with the number sent to the second node and the maximum number supported by the user equipment.

42. The first network node according to claim 38, wherein the network node is configured to:
transmit a message towards the UE comprising an indication related to the received at least one conditional configuration related to the at least one target cell of the second network node.

43. The first network node according to claim 38, wherein the conditional handover request acknowledgement comprises a number of the at least one conditional configuration included in the conditional handover request acknowledgement.

44. A second network node configured to support establishing a connection towards a user equipment, UE, via a radio access network, the second network node comprising:
at least one processor; and
at least one memory storing instructions that, when executed by the at least one processor, cause the second network node at least to:
receive a conditional handover request for the UE from a first network node, the conditional handover request comprising an indication related to a number of conditional configurations the second network node is allowed to prepare for the handover;
determine, based on the received conditional handover request, that multiple target cells controlled by the second network node are to be prepared for the handover; and
transmit a conditional handover request acknowledgement towards the first network node comprising at least one conditional configuration related to at least one target cell for the handover.

45. The second network node according to claim 44, wherein the received conditional handover request comprises information on radio measurements for target cells made by the UE and the second network node is configured to:
determine a number of target cells and of respective conditional configurations potentially available for the conditional handover request based on the radio measurements and the number of conditional configurations the second network node is allowed to prepare for the handover.

46. The second network node according to claim 44, wherein the second network node is configured to:
transmit a request for preparing a plurality of target cells for the handover towards a secondary node; and
receive an acknowledgement from the secondary node comprising conditional configurations for the prepared target cells.

47. The second network node according to claim 46, wherein the second network node is a target master node for dual connectivity of the UE in the radio access network, the request for preparing a plurality of target cells is a secondary node, SN, addition request, and the conditional handover request comprises an indication of a primary cell, PCell, associated with the second network node, and the conditional handover request acknowledgement comprises one or more indications of secondary cells, PSCells, associated with the secondary node.

48. A user equipment, UE, configured to operate in a radio access network, the UE comprising:
at least one processor; and
at least one memory storing instructions that, when executed by the at least one processor, cause the UE at least to:
indicate towards the network the number of conditional configurations for a conditional handover that the UE can support;
transmit measurements for target cells for a potential handover towards a network node; and
receive from the network node a message for conditional handover comprising an indication related to at least one conditional configuration related to at least one of the target cells.

49. The user equipment of claim 48, configured to:
evaluate the at least one conditional configuration, and in case at least one condition holds, execute a handover towards the target cell associated with the met condition.

50. A system, comprising:
a first network node according to claim 38; and
a user equipment, UE, according to claim 48 served by a cell of the first network node.

51. A method of a first network node configured to support establishing a connection towards a user equipment, UE, via a radio access network, the method comprising:
determining to prepare a conditional handover for the UE towards a second network node based on measurements performed by the UE;
transmitting a conditional handover request for the UE towards the second network node, wherein the conditional handover request includes an indication related to a number of conditional configurations the second network node is allowed to prepare for the handover; and
receiving a conditional handover request acknowledgement from the second network node comprising at least one conditional configuration related to at least one target cell for the handover.

52. A computer program comprising instructions for causing an apparatus to perform the method according to claim 51.

53. A memory storing computer readable instructions for causing an apparatus to perform the method according to claim 51.
